(19) United States
(12) Patent Application Publication
(10) Pub. No.: US 2015/0006341 A1
(43) Pub. Date: Jan. 1, 2015

(54) BILLING TRANSACTION SCHEDULING

(71) Applicant: MetraTech Corp., Waltham, MA (US)

(72) Inventors: Jonah Egenolf, Winchester, MA (US); Robert Parks, Weston, MA (US)

(21) Appl. No.: 13/929,304

(22) Filed: Jun. 27, 2013

(51) Int. Cl. G06Q 20/14

(52) U.S. Cl. CPC G06Q 20/14
USPC 705/34

(57) ABSTRACT

An billing apparatus and billing method for scheduling work in a billing system as described herein.

### BACKGROUND

Billing systems can set rates/charges according to an aggregate decision model. In general, an aggregate decision can include any decision that requires the consideration of a set of events to appropriately be evaluated (e.g., as opposed to a decision that can be made based on a single event). Thus, it can be necessary for a billing system to consider multiple transactions or usage events when determining the appropriate rate or charge for an account.

### SUMMARY

An apparatus and method for completing billing work and processing of account usage that attempts to reduce the load on a scheduler by self-scheduling work for a billing system at a billing processing node and by distributing the scheduling function amongst multiple scheduling nodes is described herein.

In some examples, the systems and methods described herein can utilize a centralized work scheduler that allocates scheduling tasks amongst multiple billing work schedulers, which in turn allocate the processing to processing nodes. The processing nodes can implement greedy scheduling in which a processing node that processes billing usage/transactions for a particular account or set of accounts attempts to self-schedule additional work not assigned to the billing processing node by the scheduler as long as the processing node can obtain locks on the other accounts potentially impacted by processing of the work. The processing node can incorporate as much related work as possible assuming the appropriate locks on other account(s) are available.

### BRIEF DESCRIPTION OF THE DRAWINGS

FIG. 1 is a schematic diagram of a billing system.

FIG. 2 is an exemplary diagram of billing work scheduling in a billing system.

FIG. 3 is a flow chart of a process for scheduling billing work using a central scheduler and multiple billing processing nodes.

FIG. 4 is a flow chart of a process for scheduling additional work at a spelling processing node by setting and updating processing breakpoints.

FIG. 5 is a flow chart of a process for determining if billing work is pipelineable.

FIG. 6 is an example of scheduling billing work for multiple accounts.

FIG. 7A is a schematic diagram of a billing system with a distributed scheduler.

FIG. 7B is an exemplary diagram of billing work scheduling in a billing system with a distributed scheduler.

FIG. 8 is an example of boundary groups.

FIG. 9 is a schematic diagram of a billing system with a distributed scheduler.

FIG. 10 is an exemplary diagram of billing work scheduling in a billing system with a distributed scheduler.

### DETAILED DESCRIPTION

An apparatus and method for processing billing information for accounts in a billing system is described herein. The systems and methods described herein provide the ability to define and implement decisions which require the consideration of a set of events (e.g., a set of transactions or usage events) to appropriately be evaluated and applied to an account. This includes aggregate rating, discounting, surcharging, charge generation, credit generation, etc. For example, information about a particular transaction/usage for an account can be used in aggregate with information about other transactions/usages for other accounts to calculate a rate, discount, or charge. Thus, billing work (e.g., actions ready for processing at a particular time for a set of accounts in order to determine billing information) in the billing system can rely on multiple usages belonging to one or more accounts.

In many situations, when the billing system processes work (e.g., processes a set of usage records that must be considered and processed through a set of decisions in a defined order), the processing relies on aggregate decision models in which the processing of any one particular usage record is potentially affected by other usage records. Such aggregate decisions can span a single account or multiple accounts. Thus, the billing system is configured to process aggregate decisions that require the consideration of a set of usage records to be appropriately evaluated (e.g., in contrast to a decision they can be made by looking at a single usage record). One example of such an aggregate decision can be rates, discounts or charges based on consumer usage such as charges that are generated if a customer accrues too much usage or doesn't meet a minimum commitment level. In another example, a discount can be provided to all accounts having a particular characteristic if certain events occur. In yet another example, usage restrictions can be applied to a group of individual accounts such as a family or organization and charges can be based on aggregate usage levels for the group of accounts.

Due to interrelation of transactions/usages and accounts, the billing system processes work in a logical order. For example, the billing system processes a set of usage records through a set of decisions in a defined order. In order to process the work in the defined order, each piece of work in the billing system is assigned a priority and the billing system processes the work for any particular account in priority order. Thus, for any account the highest outstanding priority billing work for the account is processed before lower priority billing work.

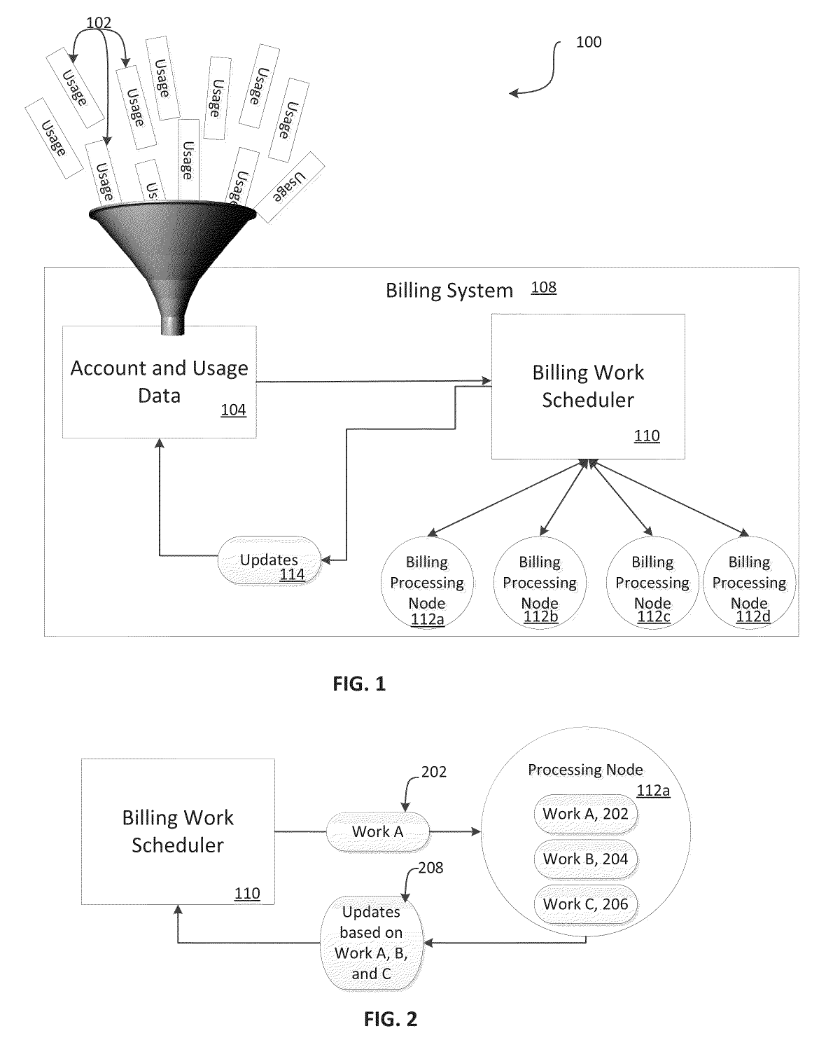

Referring to FIG. 1, a system 100 for processing billing work is shown. Usage events 102 enter the billing system 108 from external systems as usage messages or records that include usage information. The billing system 108 processes the usage indicated by the received usage events 102 through a series of one or more decisions/calculations in a predefined priority order. When the usage information 102 enters the system, it is stored in an account and usage module 104. For example, the information can be stored in a memory. Examples of usage information include phone calls, network usage events, service interactions etc.

Prior to processing the usage information, a billing work scheduler 110 analyzes the work that needs to be processed to understand how to schedule that work such that any given decision path for any given usage event 102 is processed in the correct sequence and with the correct group of events. More particularly, the account and usage module 104 stores information about accounts in the billing system 100 including the pricing/cost model applied to each of the accounts. This model includes information about how to process usage for the account to determine the charges for the account. These processing decisions make up the work which must be processed/completed by the billing system. Thus, the processing of usage records through the decisions based on the billing models can be divided into discrete pieces of work within the system. Examples of such work include items such as Examples of work items include items such as volume-based discounting across an affinity group, commission compensation for accounts delivered by resellers, bulk volume-based pricing across a corporate hierarchy.

Due to the number of accounts, amount of usage and complexity of the work, the billing work scheduler 110 is designed to parcel the work to various processing nodes 112a-d and the processing nodes 112a-d will complete the actual processing required to complete the work. Once the work is complete, the processing nodes 112a-d send information 114 indicating its completion to the work scheduler 110. The processing node is responsible for all data source modifications. Only the list of completed work is remitted back to the work scheduler. The most granular unit of work from the perspective of the scheduler is an account/work combination. The scheduler never considers the usage belonging to the accounts in question. Any usage processing is managed on the processing nodes and in-flight usage is passed from one processing node to another whenever necessary. The work schedule is never involved. This moves the work granularity for work scheduling up to the account level rather than at the usage level.

The scheduling of work by the scheduler 110 for processing by the processing nodes 112a-d is based on a given priority level assigned to pieces of work. The scheduler 110 processes information to determine all work that needs to be processed, all work for a given account, the highest priority work for each account, and all work for a given priority. The scheduler 110 has multiple processing nodes 112a-d to which work can be routed for processing. As such, the scheduler 110 determines which of the processing nodes 112a-d to route a particular piece of work to in order to ensure that a single account is never processed by more than one processing node at a time, all work for a given account is processed in order of priority with the highest priority work processed first, and all accounts potentially impacted by a given piece of work are incorporated into that work and processed by the same processing node 112a-d. In some cases, aggregate work does not need to be processed serially. In such cases, large logical units of work can be broken up into several subunits of work, each of which can be processed in parallel. These parallelizable units of work take the form of parallel calculation followed by an audit point to reduce the calculated totals followed by parallel application. This processing sequence is extrapolated by the scheduler into discrete units of work subject to the same scheduling rules as any other piece of work.

Instead of trying to generate a full processing graph up front, the centralized, scheduler 110 looks for the highest priority work it can begin without requiring any accounts that are currently locked (e.g., accounts for which work is currently being processed on another processing node 112a-d). Every time the scheduler has available processing nodes, the scheduler 110 iterates through the highest priority work remaining in the system until it finds work for which no impacted account is currently locked. It then locks account(s) potentially impacted by the work and sends the work to the processing node. The account(s) will remain remained locked while the processing node completes the work. The account(s) will be unlocked by the scheduler 110 when the processing node to which the work was scheduled returns the completed work plus any additional work is self-scheduled. Additionally, the tasks/work available for processing will be updated to indicate completion of the process work. For example, the completed work can be removed from a work list. This will then potentially free up work available for the scheduler 110 to schedule the next time it looks for work because the accounts will no longer be locked and if work requires completion of other work prior to execution, it may be scheduled due to completion of that work.

This process repeats itself until there is no more work to be scheduled, at which point the scheduler 110 waits for all outstanding work to complete and shuts down.

Referring to FIG. 2, once work is assigned from the scheduler to a particular billing processing node (e.g., one of nodes 112a-d), the billing processing node (shown here as node 210) processes the billing work and attempts to process additional work which is pipelineable. For example, the billing processing node 210 can be handed a piece of work (e.g., Work A, 202) by the work scheduler 110. The processing node 210 executes a greedy scheduling process in which it determines what other billing work may be pipelineable and then processes such billing work (e.g., determining that work B and C, 204 and 206 can also be processed). Thus, while only work A (202) was scheduled by work scheduler 110, the processing node 210 processes Work A 202, Work B 204, and Work C 206 and returns updates to the accounts 208 based on the originally assigned and the additionally processed work.

Use of such a greedy scheduling process at the processing node 210 to identify work not allocated by the work scheduler 110 can provide various benefits such as data locality and removing some of the scheduling decisions from the work scheduler 110. More particularly, every time a processing node 210 is handed a piece of work of a certain priority (e.g., the highest priority the scheduler 110 was able to schedule when the work was distributed to the node), the billing processing node 210 will attempt to incorporate lower priority work if all accounts impacted by the lower priority work are currently owned/locked by the processing node 210 and the lower priority work represents the next highest priority work for all impacted accounts. If an account is not locked for use by the particular processing node, the processing node can request to receive a lock on the account and if all related accounts can be locked by the processing node, the work can still be incorporated. For example, the scheduler 110 can maintain a list of locked/unlocked accounts and the processing node 210 can send a request to have an account locked to the scheduler 110. In some additional examples, the locks can be distributed across the processing nodes (rather than all of the locks being maintained by a centralized scheduler). For example, a hash function (e.g., an algorithm or subroutine that maps large data sets of variable length to smaller data sets of a fixed length) can generate a hash value based on the account identifier and the hash value can indicate to which of the processing nodes maintains the lock information. For example, a function such as mod(account number, # of processing nodes) could be used to identify the node maintaining the information about whether the account is locked or unlocked. This distributes the ownership of the locks equally throughout the cluster and thus provides a level of scaling that is not possible if a single resource manages the locks (e.g., if the scheduler maintains all of the locks). Additionally, every time a set of work is completed, before returning to the scheduler 110, the processing node will determine if additional work can be processed. For example, some work requires completion of other work prior to processing thus processing of one portion of work may enable additional work for the same accounts to be processed. Once all work is completed and no more work can be incorporated via greedy incorporation, the processing node 210 returns the locked accounts to the scheduler 110 (or to the appropriate node that maintains the lock information). At this point, the scheduler 110 is again free to schedule additional work for the processing node 210.

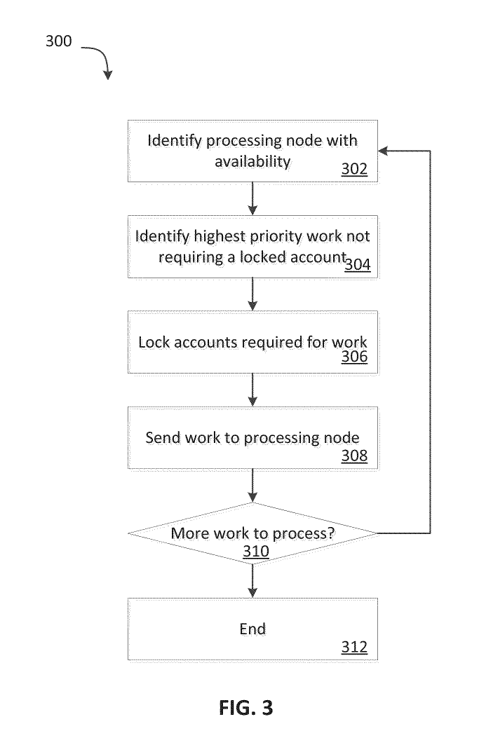

FIG. 3 shows a flow chart for a process 300 for scheduling work by the billing work scheduler 110. As noted above, in general, the scheduler 110 implements a scheduling algorithm/process that attempts to ensure that all work for a given account is processed in order of priority with the highest priority processed first, and all accounts potentially impacted by a given piece of work are incorporated into that work and processed by the same processing node.

The scheduler 110 identifies a processing node with availability (302). For example, the scheduler 110 can keep a list of processing nodes and whether they are currently allocated to process scheduled work. The status of the processing node's availability can be updated upon scheduling/completion of work. For example, upon a previously available processing node being allocated to process a particular piece of work the availability is updated to indicate that the previously available processing node is no longer available and/or upon the processing node returning a piece of work the availability can be updated such that the previously unavailable processing node is once again available for scheduling.

In addition to keeping a list or other indication of available processing nodes, the scheduler 110 also keeps information about available and locked accounts. For example, each account in the billing system can have an associated lock indicator that indicates whether the particular account is locked (e.g., currently allocated to a processing node for execution of a scheduled piece of work) or whether the account is available (e.g., currently not allocated to a processing node). As noted above, in some examples, the lock indicators can be distributed across the processing nodes (rather than all of the locks being maintained by a centralized scheduler). The scheduler also keeps information about the unprocessed work for each account and an associated priority level for each piece of unprocessed billing work. Based on the information about the available (e.g., not locked) accounts and the priority of the unprocessed work, the scheduler identifies the highest priority work that does not require a locked account in order to process (304). Since any particular piece of work may require multiple accounts in order to process the work because the usage for one account may affect the processing of another account, the scheduler 110 identifies pieces of work for which all associated accounts are available.

Once the highest priority work for which the accounts are available for processing has been identified, the scheduler 110 locks the account(s) required for the work (306). For example, the scheduler can update the lock indicator(s) associated with each of the account(s). The scheduler 110 then sends the identified work to the available processing node (308).

The scheduler determines if there is more work to process (310) and iterates the identification, locking and work allocation (304, 306, 308) until all work has been processed and process 300 ends (312).

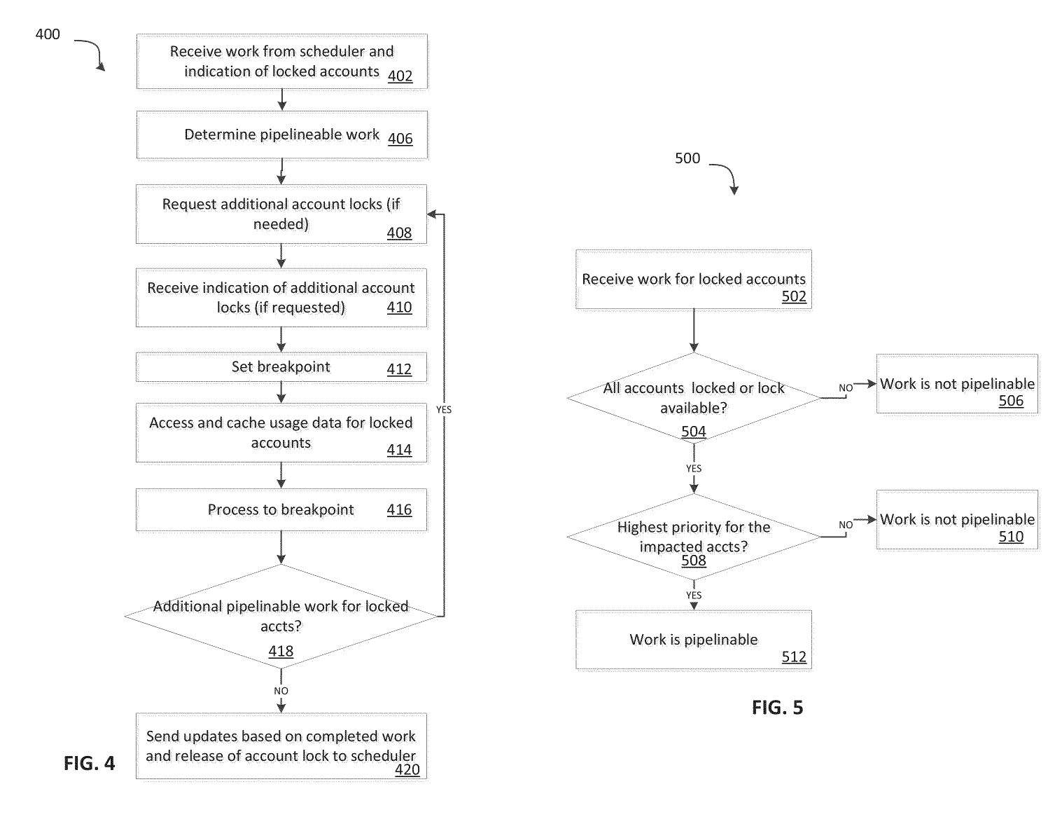

Referring to FIG. 4, a process 400 for determining work for execution on a particular billing processing node and processing the determined work is shown. The process begins with a processing node receiving from the scheduler a particular piece of work and an indication of one or more accounts allocated to the processing node in order to process the work (402). The accounts allocated the processing node are locked by the scheduler (or by the appropriate node(s) that maintains the lock information for the accounts) upon sending the work to the processing node. As noted above, the work received at the processing node will be the highest priority work that the scheduler could schedule based on the availability of account locks. After receiving the particular piece of work, the processing node determines whether additional work exists that is pipelineable (406). An exemplary process for determining pipelineable work is described in relation to FIG. 5. In general, pipeline-able work is work that can be completed without requiring other not previously completed work to first be complete. In order for a particular processing node to process additional pipelineable work, the processing node must assess other accounts which may potentially be impacted by the processing and whether the processing node already possesses or can obtain a lock on the potentially impacted account(s). If the processing node cannot obtain the needed account lock(s) then the work requiring the account locks is not pipelineable.

For work determined to be pipelineable, if additional account lock(s) are needed by the processing node, the processing node requests the account lock(s) from the scheduler or from the appropriate node(s) that maintains the lock information for the accounts in a system having lock information that is distributed (408). If the scheduler is able to provide the requested account lock(s), the processing node receives information indicating that it has been allocated the requested account lock(s) (410). The processing node sets a breakpoint based on the pipelineable work (412). The breakpoint indicates the work that can be processed by the processing node by providing a predefined stopping point for processing. For example, the breakpoint can be based on priority and all work for the set of accounts having a priority greater than the breakpoint can be processed.

Based on the work included prior to the breakpoint, the processing node pulls usage data either from the database (414) or the database will tell it which processing node currently holds the usage data if it has already been extracted. More particularly, once a processing node knows the breakpoint (and thereby the scope of all work it will process prior to the breakpoint), the processing node obtains the usage data that will be used to evaluate the aggregate decisions prior to the breakpoint. This usage data can be read from a central database (as well as zero or more processing nodes if necessary) and stored in a cache or other memory associated with the processing node.

Once the breakpoint has been set, the processing node can iterate through all the usage, and for each usage event iterate through all the decisions currently being processed in order of priority (416). Once reaching the breakpoint (e.g., all work prior to the breakpoint has been processed), the processing node re-determines if there is additional work for the locked accounts (418). If so, then the processing node requests any additional locks, sets a new breakpoint, pulls any additional usage data not previously cached by the processing node, and processes the usage prior to the newly updated breakpoint (408, 410, 412, 414, 416). Once there is no additional pipelineable work identifiable by the processing node, the processing node sends an update to the scheduler indicating what work has been completed and releasing the locks on the accounts that were previously locked by the processing node (420). Thus, while a single piece of work was scheduled by the scheduler, multiple pieces of completed work are returned to the scheduler.

In some examples, pipeline-able work is work that can be completed on a single usage event before prior work on future events has been completed. Work can be based on a set of usage records that must be considered in a defined order being processed through a set of decisions that must be evaluated in a defined order. As the set of usage events is the larger set, it is used as the probe into the relevant decisions. If decision 1 can complete its calculation on usage event 1 before decision 1 considers usage event 2, then decision 2 is considered pipelineable because the state of usage event 1 will be effectively post-decision 1 by the time decision 2 considers it before any decision considers usage event 2. Since the usage events are the probe, it means the following processing order is possible:
process usage event 1 through decision 1
process usage event 1 through decision 2
process usage event 2 through decision 1
process usage event 2 through decision 2

If decision 1 required usage event 2 to correctly impact usage event 1, then decision 2 is not pipelineable, so the following processing order would have to be respected:
process usage event 1 through decision 1
process usage event 2 through decision 1
process usage event 1 through decision 2
process usage event 2 through decision 2

The performance benefit of the former processing order becomes obvious when considering that the number of usage events can be very large and thus not always kept in memory. The latter model required iterating through the usage events multiple times which would force reading/writing the usage event from/to disk for each iteration through the usage. And functionally, it is important to abide by these ordering instructions to ensure the calculations are correct. Also note that decisions have the ability to inject (create) new usage events, but the same pipeline determination logic applies to injected usage events.

FIG. 5 shows a process for determining what billing work is pipelineable for a particular processing node. The process 500 includes receiving information about work to be completed for a set of accounts for which the processing node possesses a lock. This information is available from either the scheduling node or the central database and can be accessed by any of the processing nodes at any point. For each piece of work, the processing node can determine if the work is currently pipelineable by determining if all accounts affected or potentially impacted by the work are locked or the lock is available (504) and the piece of work is the highest priority work for the impacted account (508). If both of these determinations are true, then the work is pipelineable (512). If either of these determinations are false, then the work is not currently pipelineable (506, 510).

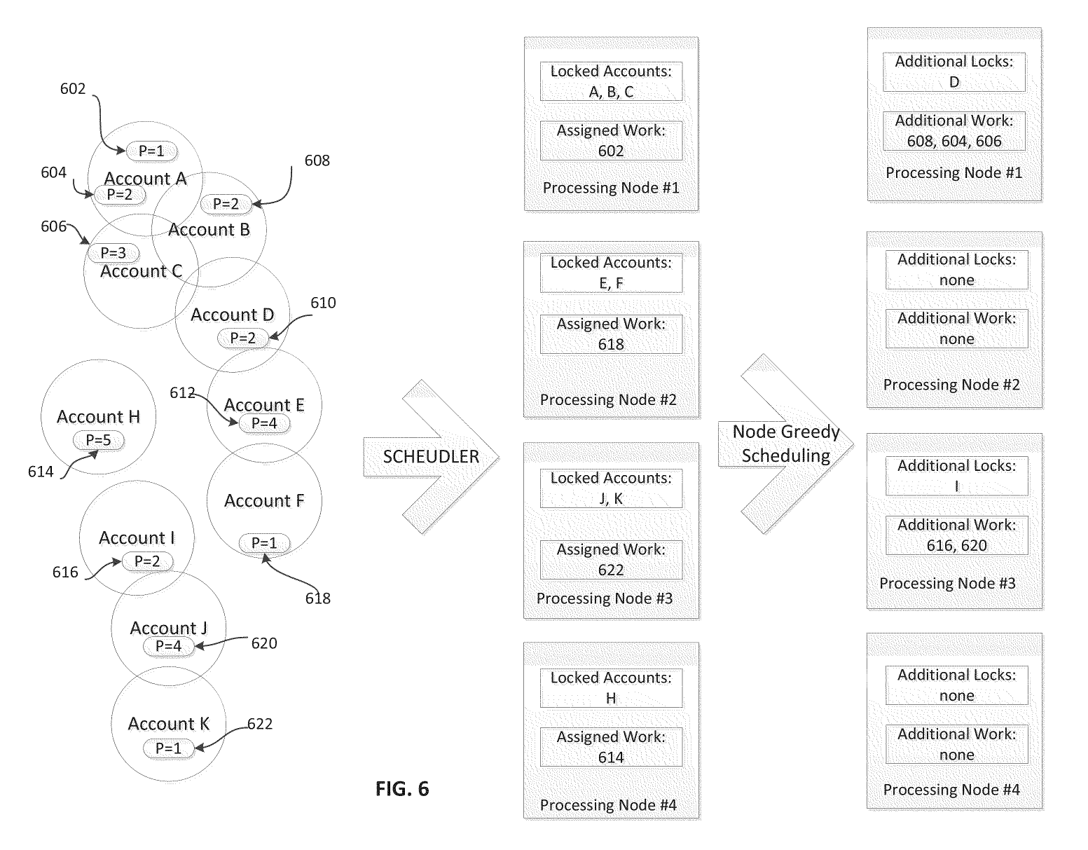

FIG. 6 shows an example of billing work scheduling using the above processes to determine pipelineable work and greedy schedule the work at processing nodes. In the example shown in FIG. 6, for simplicity of illustration there are 10 accounts and four processing nodes represented. However, the billing system is likely to have a much larger number of accounts and processing nodes. As shown on the left hand side of FIG. 6, a set of accounts are interrelated such that work for one account may impact work for other accounts. For example, work for account ‘A’ may affect processing of work for accounts ‘B’ and ‘C’ (shown pictorially as the overlapping account circles). Similarly work for account ‘B’ may affect work for account ‘A,’ ‘C,’ and/or ‘D.’ Each piece of work is assigned a given priority within the system (represented pictorially as an oval with an indication of “P=x”). For example, account ‘A’ has two associated pieces of work 602 and 604 with priorities of one and two, respectively.

As noted above, the scheduler attempts to schedule the highest priority work for which all affected accounts are un-locked. In this example, the highest priority work is work labeled ‘P=1’. Thus, assuming that processing nodes #1, #2, #3, and #4 are all initially available, the scheduler assigns a piece of priority one work to processing node #1. In this example, a piece of work 602 is assigned to processing node #1. Because this piece of work may affect not only account ‘A’ but also accounts ‘B’ and ‘C’, the scheduler locks accounts ‘A,’ ‘B’ and ‘C’ for use by processing node #1. The scheduler then attempts to locate other priority one work to schedule at the remaining processing nodes. This results in processing node #2 being assigned a piece of work 618 and being given locks for accounts ‘E’ and ‘F’ and processing node #3 a piece of work 622 and given locks on accounts ‘J’ and ‘K.’ At this point, processing node #4 is still available for processing. The scheduler reviews the work and priority and determines that all priority one through four work in the system requires access to one or more locked accounts. As such, the scheduler schedules a piece of work 614 with a lower priority of five to processing node #4. After being assigned a piece of work, each of the processing node attempts to greedy schedule additional work for the locked accounts. For example, processing node #1 was assigned a piece of work 602 and possesses locks on accounts ‘A’, ‘B’ and ‘C.’ Assuming that the work does not require ordered completion, processing node #1 can schedule the piece of work 604 without obtaining additional locks. Processing node #1 will also request a lock for account ‘D’ so that it can schedule pieces of work 606 and 608. Thus, by greedy scheduling, processing node #1 is able to schedule additional pieces of work and obtain a lock on an additional account. In contrast, when processing node #2 attempts to greedy schedule additional work, it is unable to do so. More particularly, in this example, processing node #2 possesses locks on accounts ‘E’ and ‘F.’ while an additional piece of work 612 exists for account ‘E’ processing of this work would require a lock on account ‘D’ and since the lock for account ‘D’ was previously allocated to processing node #1, processing node #2 is unable to greedy schedule additional work. Processing node #3 is able to obtain an additional lock on account ‘I’ and greedy schedule additional work 616 and 620.

Distributed Scheduler

In some examples, in addition to distributing processing amongst multiple processing nodes, the scheduling of work can also be distributed. For example, the system can include a distributed scheduling mechanism that includes a central scheduler that assigns blocks or groups of work to other scheduling nodes and those scheduling nodes assign the work to particular processing nodes. Distributing scheduling of the work amongst multiple scheduling nodes can reduce or eliminate bottlenecks that might otherwise occur due to processing restraints of a centralized scheduler such as the billing work scheduler 110 shown in FIG. 1.

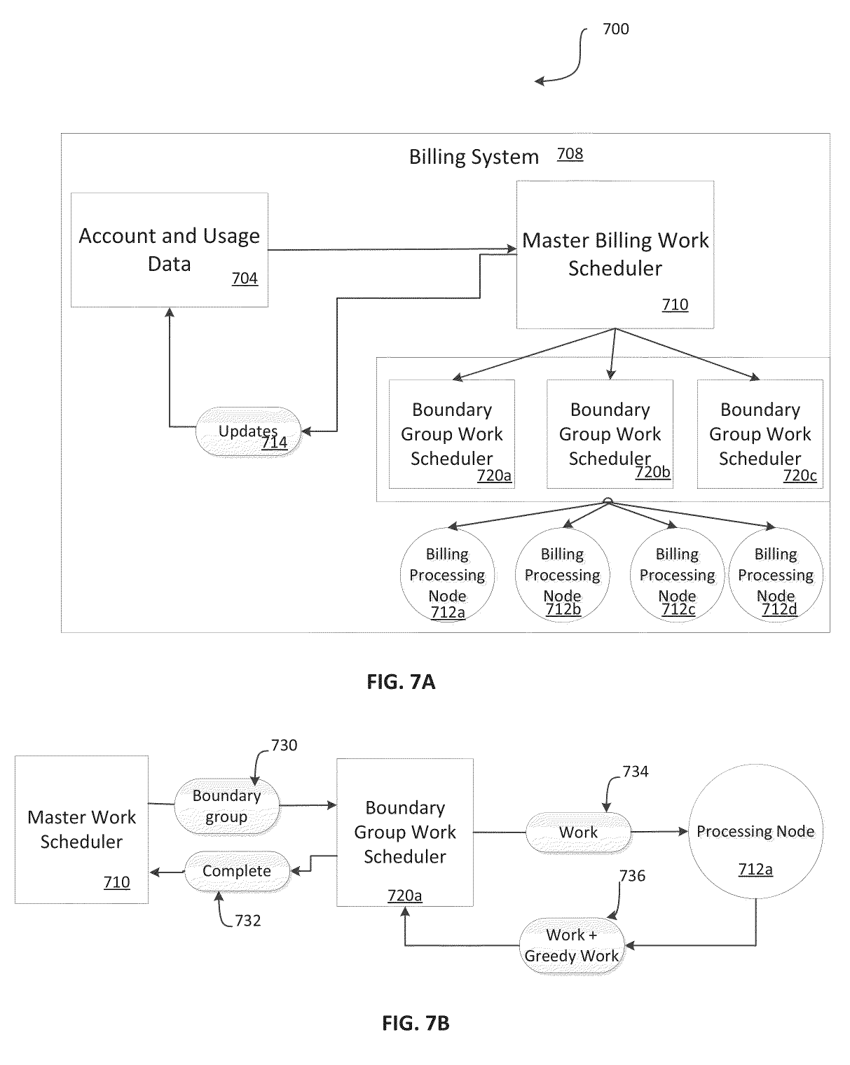

FIG. 7A shows an example of a billing system 708 that includes a master or central work scheduler 710 and multiple, additional scheduling nodes 720a-c. Similar to the system shown in FIG. 1, usage events enter the billing system 708 from external system(s) as usage messages or records that include usage information. The billing system 708 processes the usage indicated by the received usage events through a series of one or more decisions/populations in a defined priority order. When the usage information first enters billing system 708, the usage information is stored in an account and usage module 704. For example, the information can be stored in a memory.

Prior to processing the usage information, the system analyzes the work that needs to be processed to understand how to schedule about work such that any given decision path for a usage event is processed in the correct sequence and with the correct group of other events. The scheduling of the processing of work within the system is performed by the combination of a master billing work scheduler 710 and multiple boundary group work schedulers 720a-c. Due to the number of accounts, amount of usage and complexity of the work, the master billing work scheduler allocates particular groups of accounts to different boundary group work schedulers 720a-c and each of the boundary group work schedulers is designed to parcel work to various processing nodes 712a-d, which will complete the actual processing required to complete the work. Thus, the master scheduler 710 allocates scheduling of usage processing to multiple distributed boundary group work scheduling nodes.

The allocation of work from the master billing work scheduler 710 to the boundary group work schedulers 720a-c can be based on associations between different accounts within the system, such that a particular boundary group work scheduler 720a-c handles scheduling for a related set of accounts. For example, accounts can be grouped into groups (referred to herein as boundary groups) where a set of accounts that are potentially affected by transactions of other accounts in the set of accounts are included in a boundary group. In general, a boundary group can be a logically connected group of accounts that cannot be processed separately. As such, an account is unique to a boundary group. The events and transactions for accounts within a boundary group may be affected by other transactions for the same or other accounts in the boundary group but those transactions do not affect accounts or transactions outside of the boundary group.

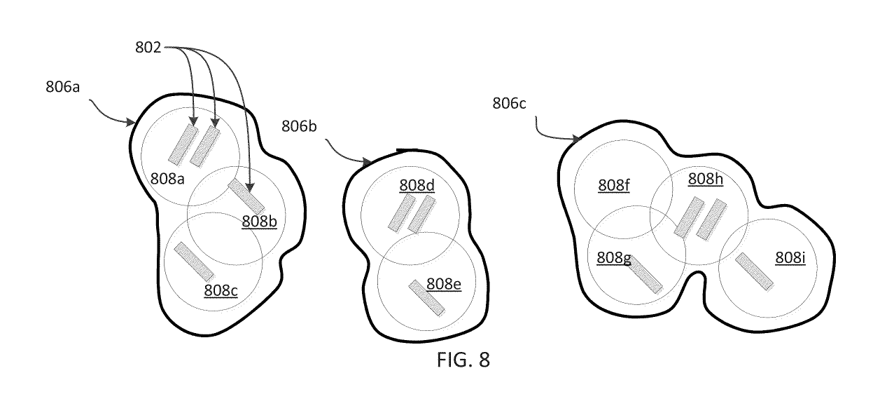

FIG. 8 shows an example of three boundary groups 806a, 806b and 806c which include accounts 808a-c, 808d-e, and 808f-i, respectively, are shown. Because billing for each of the accounts in a particular boundary group may be affected by transactions from another account within the boundary group, all transactions for accounts in a particular boundary group are scheduled by the same boundary group work scheduler. Additionally, because the boundary group includes all accounts that may be affected by the transactions of other accounts, the boundary group work scheduler can maintain locks for all of the accounts within the boundary group. Thus, distributing the scheduling of individual pieces of work can reduce the scheduling burden on the master work scheduler 710.

Referring again to FIG. 7A, in order to schedule work, the master billing work scheduler 710 determines which boundary groups have worked to be processed. The master billing work scheduler 710 also maintains a set of locks on the boundary group level. These locks are similar to the account locks described herein, but at a higher level of a boundary group. By maintaining boundary group locks, the master billing work scheduler 710 can allocate scheduling to the boundary group work schedulers when a particular boundary group has worked to be processed and the boundary group is not already being processed. Thus, by providing two levels of locks (e.g., locks on individual accounts and locks on groups of accounts at the boundary group level), the scheduling of work can be distributed in a manner similar to the distribution of processing for particular pieces of work eliminating bottlenecks that might otherwise exist due to processing required for scheduling of work. The scheduling of the actual pieces of work is performed at the boundary group work scheduler assigned to the boundary group. This scheduling is similar to the scheduling performed by scheduler 110 described above.

FIG. 7B shows an example of work assignment within billing system 708. The master work scheduler 710 identifies a boundary group work scheduler 720a with availability. For example, the master work scheduler 710 can keep a list of boundary group work schedulers and whether they are currently allocated to schedule work for a particular boundary group. The status of the boundary group work scheduler's availability can be updated upon scheduling/completion of work for a boundary group. For example, upon previously available boundary group work scheduler being allocated to process a particular boundary group the availability is updated to indicate that the previously available boundary group work scheduler is no longer available and/or upon the boundary group work scheduler returning work for a particular boundary group, the availability can be updated such that the previously unavailable boundary group work scheduler is once again available to perform scheduling for a different boundary group.

The master work scheduler 710 allocates a particular boundary group to a boundary group work scheduler 720a (as indicated by arrow 730). Upon allocation of a particular boundary group to a boundary group work scheduler 720a, the master work scheduler 710 updates the availability of the boundary group work scheduler 720a to indicate that it is currently unavailable and places a lock on the boundary group such that it cannot be assigned to another boundary group work scheduler. The boundary group work scheduler 720a is then responsible for scheduling all work for the accounts within the boundary group 730 that it has been assigned. Thus, the boundary group work scheduler keeps information about available and locked accounts in the boundary group. For example, each account in the boundary group can have an associated lock indicator that indicates whether the particular account is locked or whether it is available. As noted above, in some examples lock indicators can be distributed across the nodes rather than being maintained by a particular boundary group work scheduler. The boundary group work scheduler 720a also keeps information about the unprocessed work for each account in the assigned boundary group and an associated priority level for each piece of unprocessed billing work. Based on the information about the available accounts, the priority of the unprocessed work for accounts within the assigned boundary group, the boundary group work scheduler 720a identifies the highest priority work that does not require a locked account in order to process. Once this highest priority work is been identified, the boundary group work scheduler locks the account or accounts required for the work and sends the identified work to an available processing node 712a for processing. The boundary group work scheduler iterates the identification, locking, and work allocation until all work for the boundary group has been processed using a process similar to those described above. Upon completion of all work for the particular boundary group, the boundary group work scheduler 720a returns the completed work 732 to the masterwork scheduler 710. At this time, the lock on the boundary group is also released such that the boundary group could be assigned to another boundary group work scheduler to process other/additional work.

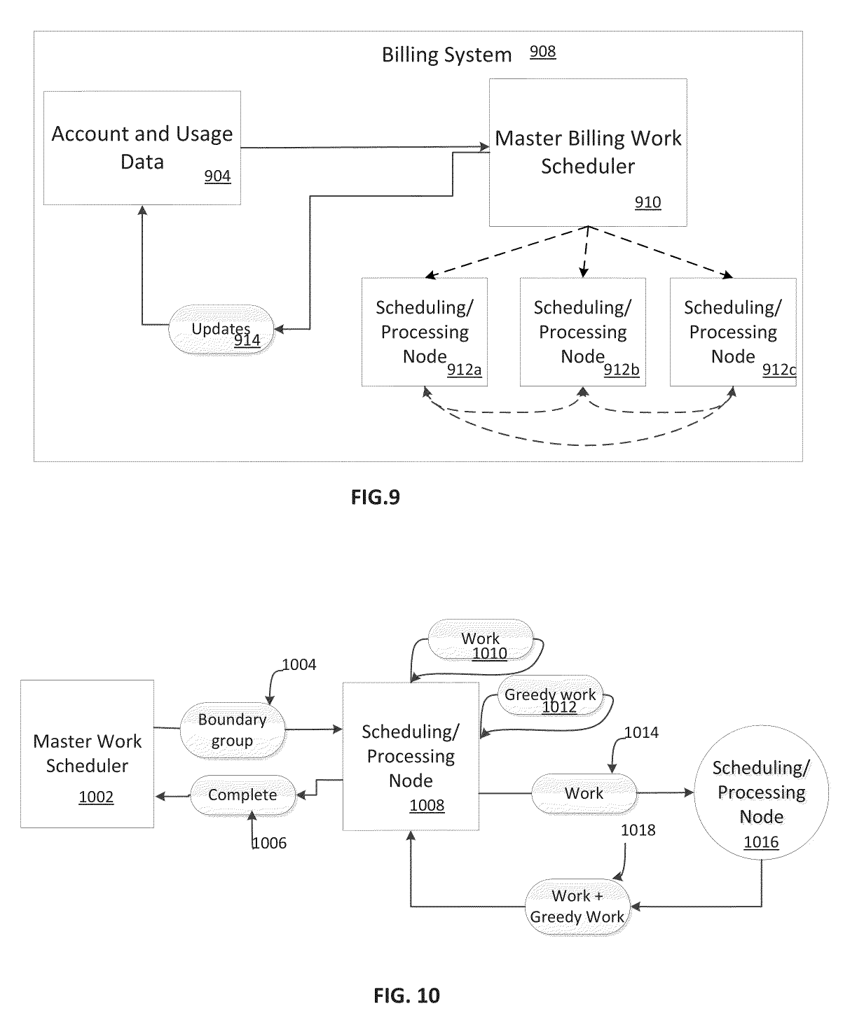

Referring now to FIG. 9, a billing system 908, in which a master billing work scheduler 910 assigns work to multiple, different scheduling/processing nodes 912a-c is shown. In contrast to the system described above in relation to FIG. 8A, which included dedicated boundary group work schedulers 720a-c for scheduling work for particular boundary group, billing system 908 includes scheduling/processing nodes 912a-c which can be used for both scheduling and processing of billing work for a boundary group. For example, when a boundary group includes a small number of accounts rather than have a node dedicated to scheduling work for the boundary group and having the work processed by a separate processing node, a single node can perform the tasks of scheduling and processing. In such a system, a master or central work scheduler 910 assigns scheduling/processing for a particular boundary group to one of the scheduling/processing nodes 912a-c.

As shown in FIG. 10, the masterwork scheduler 1002 assigns a particular boundary group 1004 to a scheduling/processing node 1008. The scheduling/processing node can proceed in one of two ways based on the amount of work for the boundary group 1004.

If the amount of work for the boundary group is below a predefined threshold, the scheduling/processing node 1008 completes the work 1010 and completes any greedy work 1012 that can be processed. After the work 1010 and greedy work 1012 have been processed, the scheduling/processing node 1008 returns the completed work 1006 to the masterwork scheduler 1002 and the scheduler 1002 releases the lock on the boundary group.

If the amount of work is larger and exceeds a predefined threshold, the scheduling/processing node 1008 may complete some portion of the work itself while sending additional portions of the work 1014 to another scheduling/processing node 1016. That scheduling processing node 1016 completes the assigned work 1014 and any additional greedy work and returns the assigned work and greedy work 1018 to the scheduling/processing node 1008. As such scheduling/processing node 1016 performs the function of only processing assigned work and not scheduling work for a particular boundary group. In this example, the scheduling/processing node 1008 is able to assign work to another scheduling/processing node 1016 because scheduling/processing node 1008 maintains locks for all accounts within the boundary group assigned to scheduling/processing node 1008. As such, work can be distributed amongst the multiple scheduling/processing nodes (e.g., nodes 912a-c in FIG. 9) with some of the scheduling/processing nodes performing both scheduling and processing functions while others can temporarily be assigned to perform processing functions alone.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can also optionally include, in addition to hardware, code that creates an execution environment for the computer programs in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A billing system comprising:
a master work scheduler configured to maintain information about boundary groups available for processing and assign boundary groups for work scheduling;
a plurality of work scheduling nodes, each of the work scheduling nodes being configured to receive an assigned boundary group from the master work scheduler and schedule work for the assigned boundary group;
a plurality of billing processing nodes, each of the billing processing nodes being configured to maintain information about accounts locked for processing by the billing processing node, process a particular piece of billing work assigned by the work scheduling node, and self-schedule additional billing work.

2. The system of claim 1, wherein each of the billing processing nodes is configured to self-schedule the additional billing work by determining, from a set of unprocessed work to be completed by the billing processing node, additional work for the accounts locked for processing by the billing processing node where the work represents the next highest priority work for a set of accounts impacted by the work.

3. The system of claim 1, wherein:
the master scheduling node is configured to maintain the boundary group lock availability information; and
the particular work scheduling node is configured to maintain account lock availability information for accounts included in the boundary group assigned to the particular work scheduling node.

4. A method for processing billing work in a billing system, the method comprising:
identifying, at a master scheduling node in the billing system, a particular work scheduling node from a plurality of work scheduling nodes available for processing;
identifying from a set of unprocessed billing work and boundary group lock availability information a boundary group that includes multiple related accounts to send to the particular work scheduling node;
receiving, at the particular work scheduling node, information about the particular identified boundary group and information about accounts for processing by the particular work scheduling node;
identifying, at the particular work scheduling node in the billing system, a particular billing processing node from a plurality of billing processing nodes available for processing; and
identifying from a set of unprocessed billing work a particular piece of billing work to send to the particular billing processing node based on a priority of the billing work and account lock availability information.

5. The method of claim 4, further comprising:
maintaining, at the master scheduling node, the boundary group lock availability information; and
maintaining, at the particular work scheduling node, account lock availability information for accounts included in the boundary group assigned to the particular work scheduling node.

6. The method of claim 4, further comprising:
receiving, at the particular billing processing node, information about the particular piece of billing work and information about accounts locked for processing by the particular billing processing node;
determining, at the particular billing processing node, additional billing work from the set of unprocessed work available for processing based at least in part on the information about accounts locked for processing by the particular billing processing node;
processing a set of usage records to complete the particular piece of billing work received from the scheduling node and the determined additional billing work; and
sending information about the processed billing work to the scheduling node.

7. The method of claim 4, wherein:
identifying from the set of unprocessed billing work the particular piece of billing work comprises identifying the highest priority work that can be scheduled without requiring any accounts locked for processing by another billing processing node; and
determining the additional billing work to be completed by the particular billing processing node comprises identifying lower priority work for the accounts locked for processing by the particular billing processing node where the lower priority work represents the next highest priority work for accounts impacted by the work.

8. The method of claim 4, wherein determining the additional billing work from the set of unprocessed work comprises implementing a greedy scheduling process to identify pipelineable work.

9. The method of claim 8, wherein the pipelineable work comprises work impacting only accounts locked for processing by the particular billing processing node.
